(19) United States
(12) Patent Application Publication
(10) Pub. No.: US 2005/0020108 A1
(43) Pub. Date: Jan. 27, 2005

(54) Electrical connector

(76) Inventor: Ted Ju, Taipei (TW)

Correspondence Address: BRUCE H. TROXELL;TROXELL LAW OFFICE PLLC, 5205 LEESBURG PIKE, SUITE 1404, FALLS CHURCH, VA, 22041, US

(21) Appl. No.: 10/627,268

(22) Filed: Jul. 24, 2003

(51) Int. Cl. H01R 12/00

(52) U.S. Cl. 439/83

(57) ABSTRACT

An electrical connector is bonded to a circuit board by solder materials. The solder materials are well arranged so that no short circuits occur. The electrical connector can be applied in a wide range of uses with high yield and reduced cost. The electrical connector has an insulator having a plurality of terminals and a solder material therein. The electrical connector is characterized by the insulator being provided with a plurality of overflow holes in a direction along which the insulator and terminals apply pressure to the solder material.

### BACKGROUND OF THE INVENTION

1. Field of the Invention

The invention relates to an electrical connector, and more particularly, to an electrical connector having an insulator with an overflow hole.

2. Description of the Related Art

Referring to FIG. 1 and FIG. 2, a conventional electrical connector includes an insulator 2 with a plurality of sockets 1, a terminal 3 and a plurality of solder materials 4 located inside the sockets 1. In order to prevent the solder material 4 from climbing up along the terminals 3 after being melted, which may result in soldering failure, a standoff 5 is formed in each socket 1. However, this causes another problem: the solder material 4 is squeezed by a circuit board 6 to flow upward if the circuit board 6 is not perfectly flat. There is no space to accommodate the solder material or to ventilate the air 7, so that the solder material 4 is forced to flow out through sides of the corresponding socket 1. In this manner, the solder material in adjacent sockets 1 may come into contact with one another to cause a short circuit and degrade electrical performance. FIG. 3 and FIG. 4 illustrate another conventional electrical connector in which a tail of each of terminals 8 is bent horizontally to prevent soldering failure; however, contact of solder materials 9 in adjacent sockets still occurs to cause short circuits and degrade electrical performance.

### SUMMARY OF THE INVENTION

It is therefore an object of the invention to provide an electrical connector that prevents solder material in adjacent sockets from coming into contact with one another and, thereby, prevents short circuit.

In order to achieve the above and other objectives, the electrical connector of the invention includes an insulator having a plurality of overflow holes by which solder materials in adjacent sockets are prevented from coming in contact with one another.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a portion of a conventional electrical connector;

FIG. 2 is a cross-sectional view of a portion of a conventional electrical connector;

FIG. 3 is a cross-sectional view of a portion of another conventional electrical connector;

FIG. 4 is a cross-sectional view illustrating a conventional electrical connector bonded to a circuit board;

FIG. 5 is a cross-sectional view of a portion of an electrical connector according to a first embodiment of the invention;

FIG. 6 is a cross-sectional view illustrating an electrical connector bonded to a circuit board according to a first embodiment of the invention;

FIG. 7 is a cross-sectional view of a portion of an electrical connector according to a second embodiment of the invention;

FIG. 8 is a cross-sectional view of a portion of an electrical connector according to a third embodiment of the invention;

FIG. 9 is a cross-sectional view illustrating an electrical connector bonded according to a third embodiment of the invention;

FIG. 10 is a cross-sectional view of a portion of an electrical connector according to a fourth embodiment of the invention;

FIG. 11 is a cross-sectional view of a portion of an electrical connector according to a fifth embodiment of the invention; and

FIG. 12 is a cross-sectional view illustrating an electrical connector bonded to a circuit board according to a fifth embodiment of the invention.

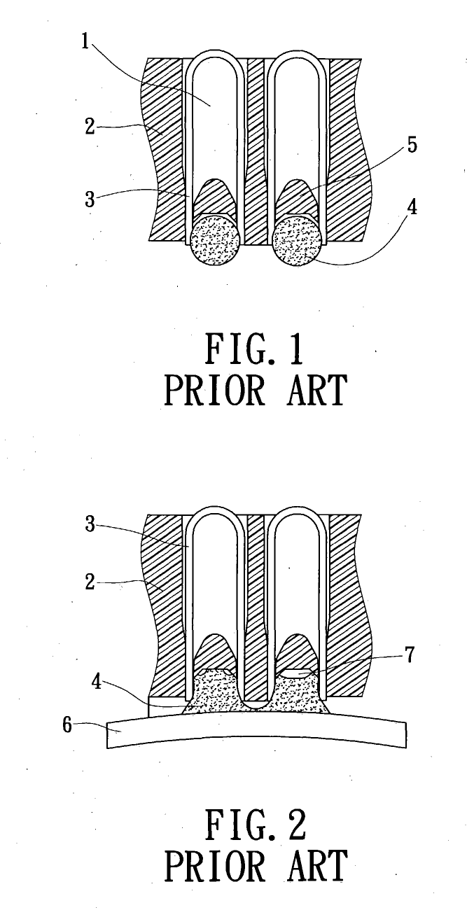

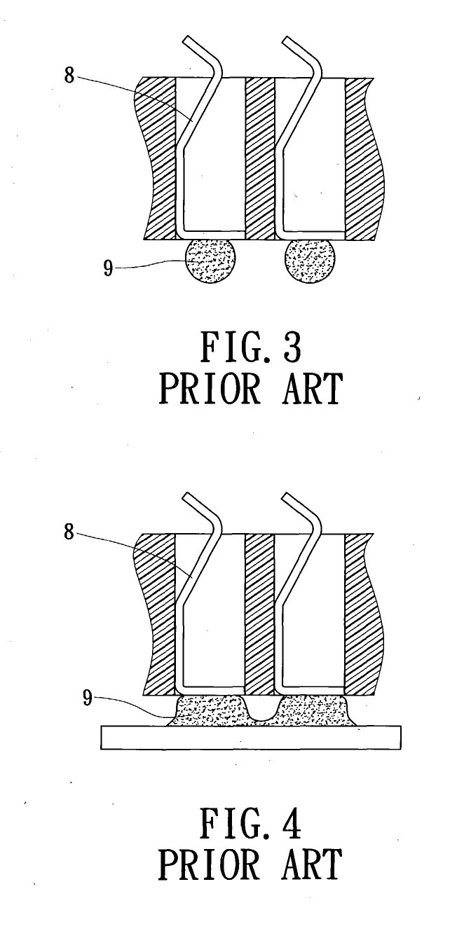

### DETAILED DESCRIPTION OF THE EMBODIMENTS

Wherever possible in the following description, like reference numerals will refer to like elements and parts unless otherwise illustrated.

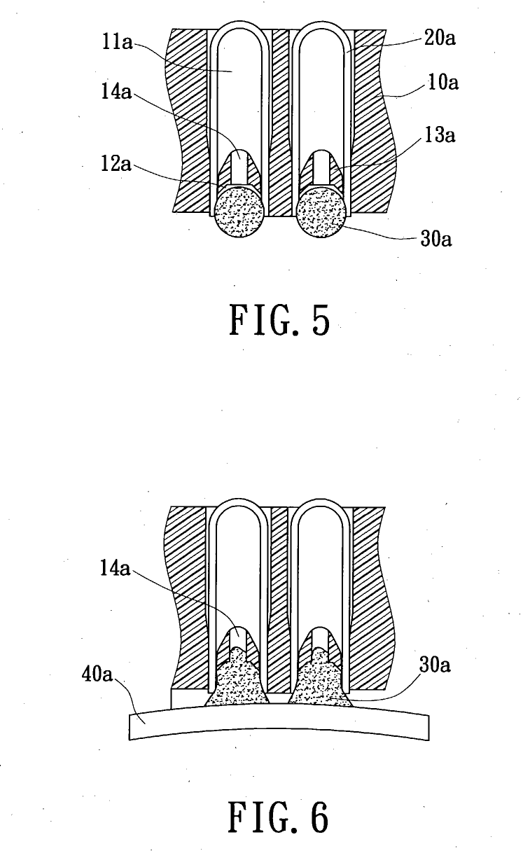

Referring to FIG. 5 and FIG. 6, an electrical connector of the invention includes an insulator 10a having a plurality of terminal slots 11a. A plurality of reversed U-shaped terminals 20a and solder materials 30 are respectively mounted inside the terminal slots 11a. A standoff 13a is formed inside each terminal slot 11a to contact with a tip of each terminal 20a. An accommodating space 12a is defined above the standoff 13a for receiving solder materials 30a. An overflow hole 14a is formed approximately at a center of standoff 13a. When the circuit board 40a is to be assembled, the solder material 30a is melted. If the circuit board 40a is not perfectly flat, then the solder material 30a is squeezed and consequently spreads out. With the overflow holes 14a, the solder materials 30a flow along the overflow holes 14a, preventing the solder materials 30a from spreading and, consequently, avoiding a short circuit. Thereby, electrical performance of the electrical connector is ensured.

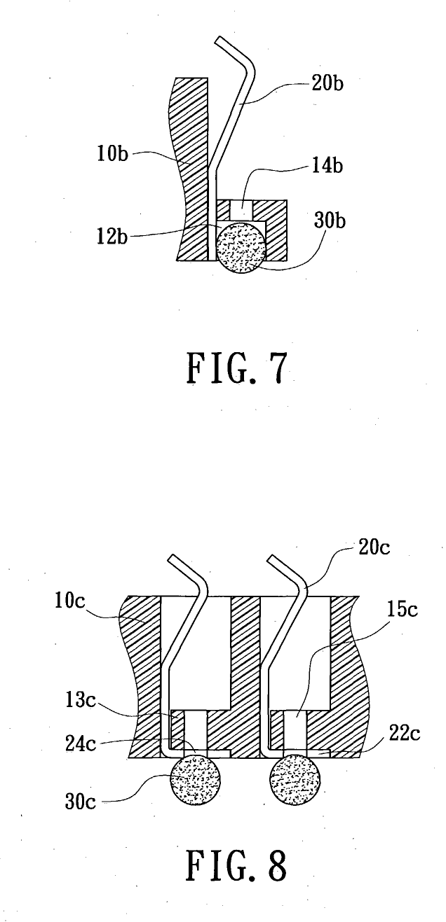

FIG. 7 shows a second embodiment of the invention. Each of terminals 20b has a flat tip that forms an accommodating space 12b with an interior of an insulator 10b for receiving a solder material 30b. A plurality of overflow holes 14b are formed inside the insulator 10b above the solder materials 30b. The overflow holes 14b prevent the adjacent solder materials 30b from contacting with one another. Thereby, short circuit is avoided and electrical performance of the electrical connector is ensured.

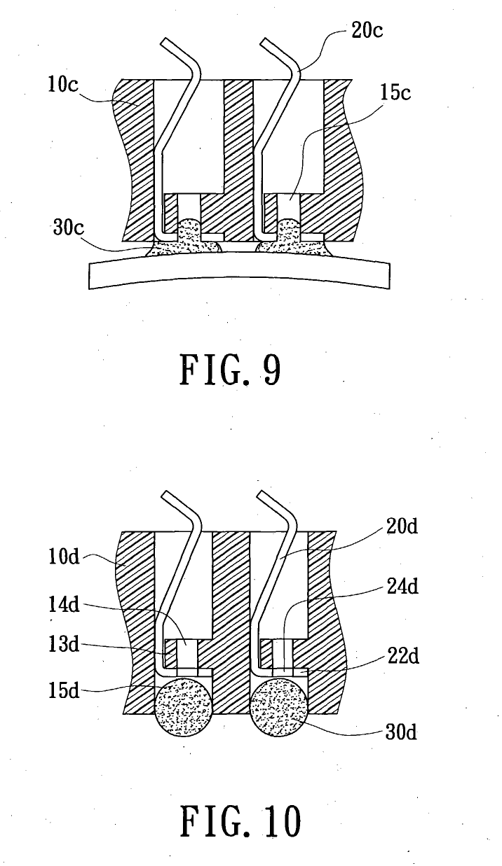

Referring to FIG. 8 and FIG. 9, each of terminals 20 is bent as a soldering part 22c. The soldering part 22c is located beneath the insulator 10c. A solder material 30c is applied over a bottom of the insulator 10c. A through hole 24c is formed approximately at a center of the insulator 10c. A standoff 13c is further formed on the bottom of the insulator 10c. An overflow hole 14c is formed in the insulator 10c to communicate with the through hole 24c. The electrical connector of this embodiment also prevents the adjacent solder materials 30c from spreading after being melted, thus preventing a short circuit.

Referring to FIG. 10, a plurality of solder slots 15d is formed near a bottom of an insulator 10d. Each of terminals 20d has a flat tip as a soldering part 22d. The soldering part 22d is secured above the solder slot 15d to contact the solder 30d inside the solder slot 15d. The soldering part 22d has a through hole 24d approximately at a center thereof. A standoff 13d is formed above the solder slot 15d in the insulator 10d. An overflow hole 14d is formed above the standoff 13d to communicate with the through hole 24d. The electrical connector of this embodiment also prevents the adjacent solder materials 30d from spreading after being melted.

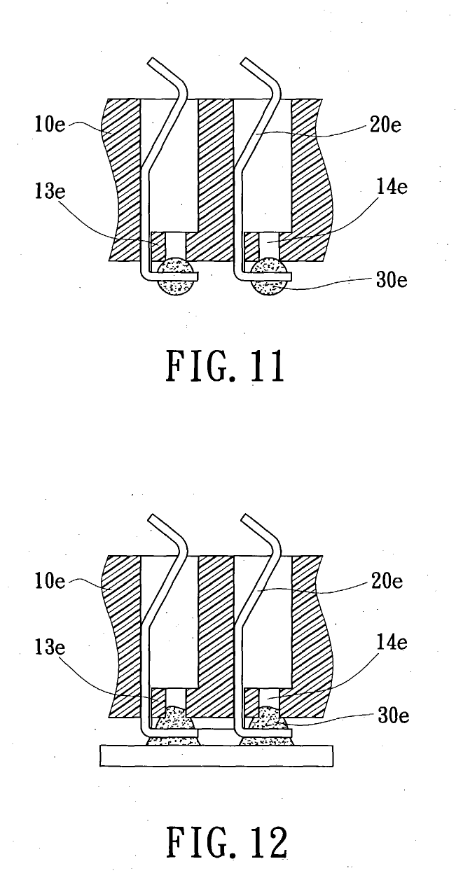

Referring to FIG. 11 and FIG. 12, each of terminals 20e is bent horizontally and inserted in a solder material 30e. An overflow hole 14e is formed above the standoff 13e. With the overflow hole 14e, the electrical connector prevents the adjacent solder materials 30c from spreading after being melted. Thereby, electrical performance of the electrical connector is ensured.

Although the overflow holes in the above embodiments are located above the solder materials, the location of the overflow holes is not particularly limited to the above embodiments.

As described above, the invention is characterized in that the electrical connector having a plurality of terminals is further provided with a plurality of overflow holes, particularly in a direction along which the insulator and terminals apply pressure on the solder materials.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1-6. (Canceled)

7. An electrical connector comprising:
a) an insulative housing having:
i) a plurality of terminal slots; and
ii) a plurality of standoffs, each of the plurality of standoffs protruding inwardly from an interior surface of one of the plurality of terminal slots and having an overflow hole therein;
b) a plurality of terminals, each of the plurality of terminals having a through hole aligning and communicating with the overflow hole, one of the plurality of terminals being inserted into each of the plurality of terminal slots, each through hole of the plurality of terminals and each overflow hole of the plurality of standoffs are the same size; and
c) solder material located in each overflow hole and through hole, wherein, during a soldering procedure, solder material automatically flows from outside the insulative housing into each of the plurality of terminal slots and into each overflow hole and through hole.

8. The electrical connector according to claim 7, wherein each through hole of the plurality of terminals is located below the overflow hole of the corresponding one of the plurality of standoffs.

9. The electrical connector according to claim 7, wherein the solder material extends from an interior of the insulative housing to an exterior of the insulative housing.

10. The electrical connector according to claim 7, wherein each of the plurality of terminals includes a bent soldering part, the through hole being formed in the soldering part.

11. The electrical connector according to claim 9, wherein each of the plurality of terminals includes a bent soldering part, the through hole being formed in the soldering part.
